(19) United States
(12) Patent Application Publication
(10) Pub. No.: US 2013/0127638 A1
(43) Pub. Date: May 23, 2013

(54) Cyclist Proximity Warning System

(71) Applicant: Cameron Harrison, Lysterfield South (AU)

(72) Inventor: Cameron Harrison, Lysterfield South (AU)

(21) Appl. No.: 13/695,959

(22) PCT Filed: Mar. 21, 2011
(86) PCT No.: PCT/AU2011/000306

§ 371 Date: Jan. 18, 2013

(30) Foreign Application Priority Data
May 4, 2010 (AU) 2010901903
Sep. 28, 2010 (AU) 2010904365

(51) Int. Cl. G08G 1/16

(52) U.S. Cl. CPC G08G 1/166
USPC 340/903

(57) ABSTRACT

A cyclist proximity warning system comprising one or more cyclist transmitter units each for carrying on a bicycle or motorcycle and one or more in vehicle driver alert devices each driver alert device for carrying in a vehicle. Each transmitter unit is adapted to transmit a signal indicating the location of the transmitter unit and the bicycle or motorcycle carrying the unit. Each in vehicle driver alert device has a receiver adapted to receive a cyclist proximity warning signal indicating presence of a cyclist proximate the vehicle and, in response to receiving the signal, alert the vehicle driver to the presence of a cyclist proximate the vehicle.

### FIELD OF THE INVENTION

The field of the invention is motor vehicle accident prevention devices.

### BACKGROUND OF THE INVENTION

Every year there are hundreds of accidents fatalities and even more injuries of bicyclists and motorcyclists on roads. The majority of such injuries and fatalities are caused by accidents between the cyclist and motor vehicles such as cars or trucks. Typically such accidents occur because the driver of the motor vehicle as not seen the cyclist.

### SUMMARY OF THE INVENTION

According to one aspect there is provided a cyclist proximity warning system comprising:

one or more cyclist transmitter units each for carrying on a bicycle or motorcycle, each transmitter unit being adapted to transmit a signal indicating the location of the transmitter unit and the bicycle or motorcycle carrying the unit; and

one or more in vehicle driver alert devices each driver alert device for carrying in a vehicle and having a receiver adapted to receive a cyclist proximity warning signal indicating presence of a cyclist proximate the vehicle and in response to receiving the signal alert the vehicle driver to the presence of a cyclist proximate the vehicle.

In an embodiment of the system the cyclist transmitter units are adapted to transmit a limited range wireless cyclist proximity warning signal for reception by any in vehicle driver alert device receiver within range of the proximity warning signal.

The range of the proximity warning signal can be adjustable.

The cyclist transmitter unit can have a low power consumption standby state where no proximity warning signal is transmitted and a higher power consumption active state wherein the proximity warning signal is transmitted, and the transmitter unit is adapted to automatically transition from the standby state to the active state in response to operation of the bicycle or motorcycle.

The cyclist transmitter unit can be adapted for installation on a motorcycle and the cyclist transmitter unit is adapted to automatically transition from the standby state to the active state in response to turning on the motorcycle engine and transition from the active state to the standby state in response to turning off the motorcycle engine.

Where the cyclist transmitter unit is adapted for installation on a bicycle and the cyclist transmitter unit can be adapted to automatically transition from a standby state to an active state in response to movement of the bicycle. A signal can be generated by operation of the bicycle pedals or wheels which is received by the cyclist transmitter unit to trigger the transition from the standby to the active state.

A transition from the active state to the standby state can be triggered in response to expiration of a specified time period after movement of the bicycle ceases.

In an embodiment an in vehicle driver alert device comprises one or more associated receivers for mounting to a vehicle and any trailer, wherein each receiver adapted to receive a cyclist proximity warning signal from a cyclist transmitter unit and in response to any one or more receivers receiving a cyclist proximity warning signal cause a diver alert to issue.

Each of the receivers can be remote from a driver alert device proximate the driver and each receiver can be in data communication with the driver alert device via a communication link.

The communication link can be a wireless communication link. For example, the communication link can be a Bluetooth communication link.

The driver alert device can be a Bluetooth enabled accessory device and can be any one of: a navigation device; a mobile telephone; smart phone; tablet or palm top computer; or personal digital assistant.

In some embodiments the in vehicle detection device receiver is a radio receiver device. For example, the in vehicle detection device can be a car radio and wherein the transmitter transmits a proximity warning signal on one or more radio frequencies receivable by the radio receiver to alert the driver to the presence of the cyclist.

For example, the signal can cause an audible warning message to be reproduced through the car radio when the proximity warning signal is received.

In an embodiment of the system the cyclist transmitter unit includes an infra red (IR) transmitter and the in vehicle detection device includes an infra red (IR) receiver.

In some embodiments the transmitter unit includes a Bluetooth transceiver and the in vehicle detection device includes a Bluetooth transceiver.

The in vehicle device can be any one of a satellite navigation device, mobile telephone hands free kit, in car communication device, or similar device having a Bluetooth transceiver.

In some embodiments transmitter units can be adapted to send the signal indicating the location of the cyclist transmitter unit to a communication network accessible server storing cyclist tracking data, and wherein a cyclist proximity warning signal is transmitted to the in vehicle driver alert device from the communication network accessible server in response to identification of a cyclist proximate a vehicle based on vehicle location.

The in vehicle driver alert device can be a satellite navigation device and cyclist tracking data is transmitted to the satellite navigation device via a satellite navigation system.

In some embodiments the in vehicle driver alert device can be a smart phone or other communication network enabled device enabled for location tracking and cyclist tracking data and executing a cyclist proximity warning software application.

The in vehicle device can be a stand alone device.

In some embodiments the in vehicle device is adapted to identify the approximate direction of origin of the proximity warning signal and indicate the approximate direction for the driver.

The driver can be alerted to the presence of the cyclist by means of one or more of an audible signal and a visual signal.

According to another aspect there is provided transmitter adapted to transmit a proximity warning signal having a specified range, whereby the proximity warning signal can be detected by an in vehicle device of a vehicle within range of the proximity warning signal and in response a motor vehicle driver alerted to the presence of a cyclist proximate the vehicle.

According to another aspect there is provided an accessory adapted to be mounted on a bicycle or motorcycle incorporating a transmitter as described above for a cyclist proximity warning system.

According to another aspect there is provided a software application adapted to, when executing on a portable communication network accessible communication device carried by a cyclist of a bicycle or motorcycle, cause the communication device to operate as a cyclist transmitter unit of a cyclist proximity warning system.

According to another aspect there is provided a software application adapted to, when executing on a portable communication network accessible communication device, to cause the device to operate as an in vehicle driver alert device of a cyclist proximity warning system.

A receiver unit adapted to receive a proximity warning signal and, in response to receiving a proximity warning signal, output a signal to trigger an alert to warn a vehicle driver of the presence of a cyclist.

According to another aspect there is provided an accessory adapted to be used in a vehicle in data communication with one or more receiver units as described above.

According to another aspect there is provided a transceiver unit adapted to operate in a transmitter mode as a cyclist transmitter unit and in a receiver mode as an in vehicle driver alert device of the cyclist proximity warning system described.

A transceiver unit as described above wherein the transceiver is adapted to detect mounting to a bicycle or motorcycle and operation is limited to receiver mode in the absence of detection of mounting to a bicycle or motorcycle.

### BRIEF DESCRIPTION OF THE DRAWINGS

An embodiment, incorporating all aspects of the invention, will now be described by way of example only with reference to the accompanying drawings in which:

FIG. 1 is an illustrative example of an embodiment of a cyclist proximity warning system.

FIG. 2 is a block diagram of an embodiment of a cyclist proximity warning system.

FIGS. 3a and 3b are exemplary circuit diagrams for an embodiment of a radio frequency transmitter unit and compatible in vehicle receiver unit respectively;

FIGS. 4a and 4b are exemplary circuit diagrams for an embodiment of an infra red transmitter unit and compatible in vehicle receiver unit respectively;

FIG. 5 is an example of an alternative in vehicle receiver.

### DETAILED DESCRIPTION

Embodiments of the present invention enable a motor vehicle driver to be alerted to the proximity of a cyclist by transmitting a proximity warning signal by a transmitter unit mounted on a bicycle or motorcycle. The driver is alerted to the presence of a cyclist in close proximity to the vehicle in response to receiving a proximity warning signal, using an in vehicle device. The proximity of the cyclist to the vehicle when the driver alert is triggered is based on the range of the proximity warning signal.

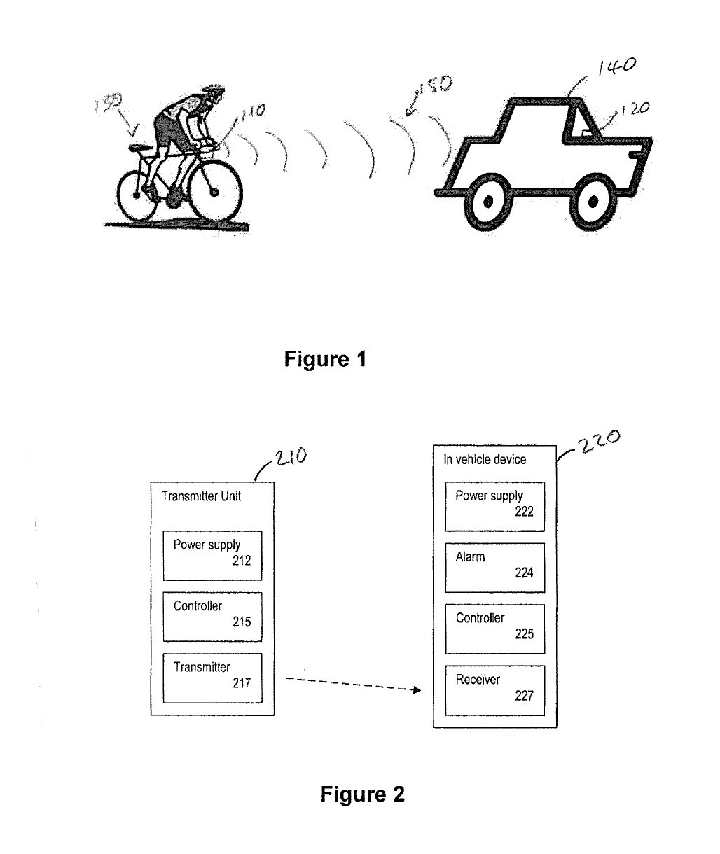

A cyclist proximity warning system according to an embodiment of the invention is illustrated in FIG. 1. The system 100 comprises a transmitter unit 110 for mounting on a bicycle 130 or motorcycle. The transmitter unit is adapted to transmit a proximity warning signal 150 for detection by an in vehicle device 120 of a vehicle 140 within range of the proximity warning signal, whereby a motor vehicle driver can be alerted to the presence of a cyclist in close proximity to the vehicle. The proximity of the cyclist is based on the range of the proximity warning signal.

The transmitter unit is typically positioned to transmit the proximity warning signal substantially forward of the cyclist in the direction of travel. However, the proximity signal may also be transmitted to the sides and rear. Most accidents between motorists and cyclists occur where the cyclist is behind or to the side of the vehicle driver, outside their forward field of vision. For example, accidents can be caused by opening a driver's door into the path of a cyclist, a motorist failing to give way at an intersection because they have not seen a cyclist, turning a corner across a cyclist's path, or a motorist moving into a cyclist's lane without seeing the cyclist. Thus, the proximity warning signal is projected at least in a forward direction.

The range of the proximity warning signal can be set to a distance that gives both a cyclist and a motorist enough space and time to the alert to be triggered before any collision or interference. For example, the range of the proximity signal may be 5 meters, thus a vehicle driver can be warned of the proximity of a cyclist approaching behind their vehicle a few meters before any overlap. In response to the warning, the vehicle driver can check their mirrors and blind spots to positively locate the cyclist and ensure that the way is clear before taking action such as changing lanes, turning, moving over to park etc.

The range of the proximity warning signal can be adjustable. The chosen range for the signal may be based on the typical speed of travel for the cyclist. For example, if a cyclist is using a road bike which they will typically ride at speeds around 30-40 kilometres per hour (kph) or more on the road the range for the proximity warning signal may be set at around 8-10 metres, whereas for a mountain bike that will typically be ridden at speeds around 15-25 kph the range may be set lower, say around 5 metres. Transmitter units designed for mounting on motorcycles may use longer ranges, for example 25 to 50 metres.

Ranges may be set based on rider ability as well as cycle type. For example a skilled motorcyclist may feel more confident than a beginner motorcyclist in their own ability to take evasive action to avoid an accident, and therefore be comfortable using a shorter proximity warning signal range, than the beginner motorcyclist.

Riding conditions, such as rain, fog, heavy traffic or open roads may also be taken into consideration when setting the proximity warning signal range. Shorter ranges can be better suited to congested traffic conditions where traffic is typically slow moving. However, on open roads where traffic is typically moving faster, longer range proximity warning signals can be more appropriate.

In some embodiments the proximity warning signal range may be dynamically adjusted based on current speed of travel. The maximum range of the transmitter may be limited, for example to 50 metres. The proximity warning signal range may be automatically increased in response to an increase in cycle speed and correspondingly decreased as the cycle speed decreases. For example, the cyclist proximity warning system may be connected to the speedometer of a motorcycle. While the motorcycle is idling at traffic lights the range of the proximity warning signal may be set to 1-2 metres. As the motorcycle accelerates from 0 to 20 kmph the range of the proximity warning signal may be increased to 5 m, from 20 kmph to 50 kmph the range may be increased to 35 m, by 70 kmph the range may be increased to 50 m, by 90 kmph the range may be increased to 75 m, from 120 kmph the range may be increased to 100 m, above 200 kmph the range may be increased to 150 m or a maximum range. It should be appreciated that these ranges are examples only and other ranges may be used. The ranges will also be different for bicycles but may be dynamically adjusted based on the bicycle speed, for example calculated based on wheel revolutions measured using a magnetic sensor and magnet attached to bicycle spokes.

The range of the proximity warning signal may be calculated to give a stationary vehicle at least a minimum period of notice of the proximity of a cyclist. For example 2-3 seconds or other period of time, which should be sufficient for a driver to react to the warning and cease any potentially dangerous action. Where a vehicle is moving in the same direction as the cyclist the warning time will be more than that of a stationary vehicle. Where a vehicle is moving in an opposite direction of the cyclist the warning time will be less, but the cyclist is also more likely to also be visible to the driver.

In some embodiments the transmitter is arranged such that the proximity warning signal transmission pattern is directional projecting the proximity signal predominantly forward in the direction of travel of the cyclist. However, alternative embodiments may transmit the signal radially evenly in all directions. Alternatively the transmission pattern may cause the signal to be projected a maximum distance forward and a shorter distance sideward and rearward of the cyclist.

Some embodiments of receivers adapted to receive and process the cyclist proximity warning signal may be adapted to identify the approximate direction of the signal. For example, the receiver may be directional. Alternatively digital signal processing of the signal may enable the approximate direction to identified, for example utilising Doppler characteristics of the received signal. This may enable a warning provided to the driver to indicate an approximate direction of the cyclist. For example, warning that a cyclist is ahead, approaching from behind, to the left or right hand side of the vehicle, on the left or right rear quarter etc. In instances where more than one cyclist is detected the direction of each cyclist may also be indicated. The direction indication may be auditory, for example by a voice signal telling the direction or utilising speakers located around the vehicle cabin, or visual, for example using lights or a display in the vehicle.

In some embodiments an in vehicle device may have a plurality of remote receivers which can be arranged around the edges of the vehicle. Each of the remote receivers is adapted to receive a cyclist proximity warning signal and send a signal to a central unit for warning the driver. The proximity warning may be signalled to the central unit via a wired or wireless interface. The remote receiver units can be adapted to be mounted around the vehicle, for example on a rear bumper, towbar, sides of a tray, on a trailer etc.

For example, if the range of a cyclist proximity warning signal is around 5 meters, this may be insufficient if a receiver is only provided near a driver in large vehicles, trucks, articulated vehicles or vehicles with trailers. If the vehicle (and any trailer) is longer than 5 meters then an overlap between the cyclist and vehicle will already have occurred before the proximity warning signal is within range of a receiver unit near the driver.

Each remote receiver unit may have an independent power supply, such as a battery or solar cell, a receiver for receiving the proximity warning signal, a means for communicating with the central unit, and control circuit. The means for communicating with the central unit may be a wireless transmitter or a direct wired connection between the remote receiver and central unit.

Where the remote units are adapted to communicate wirelessly with the central unit the remote unit may include a transceiver adapted to simply relay a cyclist proximity warning signal to the central unit. Such remote receiver units may be adapted to work with any in vehicle cyclist proximity warning device as the signal relayed by the remote unit can be received similarly to a cyclist proximity warning signal received from a cyclist's transmitter unit. The relayed signal from the remote units may be directional and the range adjustable to avoid the relayed signal being received by in vehicle devices of other vehicles.

Alternatively the remote unit may be adapted to transmit a different signal to the central unit to indicate that a cyclist proximity warning signal has been received by a remote unit. The signal transmitted may indicate which remote receiver unit received the proximity warning signal to enable the approximate location of the cyclist to be indicated to the driver. For example, the remote receiver units can include a proximity warning signal receiver and a separate transmitter tuned or coded to communicate the central unit only. When a proximity warning signal is received by the remote receiver unit a control circuit causes the transmitter to transmit a signal to the central unit. In response to receiving this signal the central unit alerts the driver. For example, Bluetooth communication may be used between the central and remote units. The central unit may be a navigation unit or other accessory (stand alone or in built) provided in the vehicle and upgraded using software with the cyclist proximity warning system functionality via a Bluetooth interface.

Remote units may be battery operated and adapted to assume low power or SLEEP state while the vehicle is not in use and an AWAKE state ready to receive the proximity warning signal. For example, transition from a wake to sleep state may occur in response to a signal from the central unit. Alternatively, motion sensors may be used to trigger transition from a sleep to a wake state based on movement of the vehicle. A control circuit can control transition back to a sleep state some time after the vehicle has stopped moving. The control unit may be adapted to periodically poll the remote receiver units and warn the driver if no response is received, which may indicate a flat battery or loss of the remote unit. In some embodiments batteries powering the remote units may be recharged using solar energy or other environmental means, such as kinetic or thermal energy, to avoid the need to physically change batteries or remove the batteries or remote units for recharging.

In an embodiment where a wired connection exits between the remote receiver unit and the central unit, a control circuit can send a signal to the central unit using the wired connection in response to receiving a cyclist proximity warning signal. A wired connection may also provide power to drive the remote units or charge remote unit batteries.

The block diagram of FIG. 2 illustrates an embodiment of a transmitter unit 210 and an in-vehicle device 220 adapted to receive the proximity waring signal. The transmitter unit 210 includes a power supply 212, a controller 215 and a transmitter 217.

The power supply 212 is adapted to supply power to the transmitter 217 and controller 215. The power supply 212 may be a battery or other power supply. For example, the power supply 212 may be a solar power supply which may also include battery storage or battery back up, or a power generator which generates power in response to movement of the cycle or components thereof. A solar power supply may also be used to charge a battery which is used as a primary power supply. The transmitter unit may also be provided with a charger or docking station to enable batteries to be recharged using mains power when the unit is not in use. Alternatively, for embodiments adapted to be used in motorcycles the transmitter unit may be adapted to connect to the electronic systems of the motorcycle and be powered by the motorcycle.

The controller 215 can be a hard wired circuit connected to the power supply 212 and adapted to control the transmitter 217 to transmit a proximity warning signal. In some embodiments the controller may include integrated circuits adapted to provide control functions. Such integrated circuits may also include programmable logic devices or microprocessors which can be selectively programmed to perform control functions. In some embodiments the controller may be adapted to perform functions other than just controlling the transmitter.

Devices which may be optionally included in control circuit are accelerometers, speed monitors or other sensors which may provide inputs to control logic for the transmitter unit. For example, in an embodiment where transmitter range is adjusted based on the speed of the bicycle or motorcycle, sensors for monitoring speed may be included or an input for a speedometer output may be provided. For example, an embodiment of the transmitter unit adapted for installation on a motorcycle may include input ports or wiring for connection to a motorcycle speedometer.

Embodiments adapted to be mounted on bicycles may include input ports for connection to sensors adapted to sense the movement of magnets connected to bicycle wheel spokes past the sensors from which the travel of the bicycle can be calculated. In some embodiments, the controller may be adapted to provide traditional cycle computer functionality such as current speed, distance travelled, cadence, etc for feed back to the cyclist. Such embodiments may also include a display such as an LCD screen for providing this feedback to the cyclist.

The controller 125 is adapted to control the transmitter 127 to transmit a proximity warning signal. The transmitter 127 can be any form of suitable wireless transmitter. The transmitter may transmit an optical signal, such an infrared signal, or a radio frequency signal, for reception by a cooperating receiver 127 of an in-vehicle device 220. For example, where the transmitter transmits an infrared signal, then the in-vehicle device 220 must include an infrared receiver 227 in order to receive the proximity warning signal. Where the proximity warning signal is a radio frequency signal, then the in-vehicle device must include a radio frequency receiver.

The proximity warning signal may have specified signal characteristics to ensure that the signal can be correctly identified as a proximity waring signal. For example, a specified carrier frequency may be used, the signal may be transmitted having a characteristic pattern of pulses, or signal data may be used to identify the signal as a cyclist proximity warning signal. Continuous or pulsed transmission of signals may be used, however it should be appreciated that a transmitter using pulsed signals may exhibit better power saving characteristics, and hence longer battery life, than a continuously transmitting embodiment. A transmitter may also be designed to use multiple transmission modes and automatically transition between these modes to cater for a variety of receivers. For example, a transmitter may be provided with both IR and RF transmitters. Alternatively, a transmitter may transition between a selection of radio frequencies and/or pulse patterns to cater to a selection of receiver types.

It should be appreciated that various embodiments of this system may be implemented using different transmitting and receiving technologies and any such embodiment is feasible provided cooperating transmitters and receivers are used.

The in-vehicle device 220 includes a power supply 222, an alarm 224, a controller 225 and a receiver 227.

In some embodiments, the in-vehicle device may be installed as part of the vehicle electronics. In such embodiments the in-vehicle device can be powered from the vehicle's electrical system and therefore not require an independent power supply 222. In stand alone in-vehicle devices the power supply 222 may be battery or solar power supply. Where a solar power supply is used a battery backup may also be provided for use in low light conditions or at night. A solar power supply may also be used to charge a battery which is used as a primary power supply. Alternatively, a device for connection to a power outlet within the vehicle may be provided to enable the device to be powered from the vehicle's power supply. For example, many devices used in vehicles such as mobile phone charges and navigation devices can draw power from the vehicle's electronic system via an outlet such as cigarette lighter using an appropriate connector, and such a connector could also be used for the power supply 222 of the in-vehicle device 220.

The alarm 224 is adapted to alert the vehicle driver in response to a proximity warning signal being received by the receiver 227. The alarm may include devices for generating an audible and/or visual alert.

The receiver 227 can be any receiver device adapted to receive the proximity warning signal transmitted by the transmitter 217. The type of receiver 227 used is dependent on the type of transmitter used. It is envisaged that the type of transmitters and receivers used for the cyclist proximity warning system may be prescribed by a government body or similar authority to ensure compatibility between transmitter units mounted on bicycles or motorcycles and receivers or in vehicle devices which may take a variety of forms. It is envisaged that standard receiver requirements may be mandated by government bodies or a de-facto standard developed through cooperation between the vehicle industry and safety bodies to ensure compatibility between receiver and transmitter units.

The controller 225 is a circuit or other control device connected to the receiver and the alarm 224 in order to control the issuance of the alarm in response to the receiver 227 receiving a proximity warning signal. The control 225 may be implemented using any appropriate hardware and software configuration. For example, the controller 225 may include a micro-processor or programmable logic and supporting circuitry for connection to the power supply receiver and alarm. Alternatively, the controller 225 may be in the form a hardware circuit comprising discrete components mounted on a circuit board and the components of the receiver alarm and power supply may be included in this control circuit.

In some embodiment, the in-vehicle device 220 may be implemented as part of the vehicle electronics, for example integrated into the vehicle's radio, navigation system or other systems such as parking assistance systems. In other alternative embodiments the functionality of the proximity in-vehicle device may be implemented in another vehicle accessory device, such as a stand alone navigation system, hands free mobile telephone kit, toll tag or in the vehicle installed component of a vehicle to vehicle (V2V) or vehicle to infrastructure (V2I) communication system. Enabling the functionality to be added after market and in conjunction with another useful accessory may improve the adoption of the cyclist proximity warning system in vehicles. The functionality of the in-vehicle device may also be implemented in a software application for a mobile phone, smart phone, for example an iPhone™ or Android™ operating system phone, tablet or compact computer, personal digital assistant etc. In some embodiments the receiver for the proximity warning signal may be a Bluetooth, IR, FM radio receiver or other short range wireless receiver built into the device and compatible with the transmitter. For example, a software application may be adapted to tune an FM radio signal receiver of a phone to a frequency designated for the cyclist proximity warning signal. Alternatively, a Bluetooth interface may identify a cyclist transmitter unit. The application may be adapted to monitor an IR or wireless receiver for the proximity warning signal. When a proximity warning signal is received the application causes a visual and audible alert to be emitted from the phone. Alternatively a receiver may be plugged into the device for receiving the cyclist proximity warning signal. It should be appreciated that any suitable device may be modified using an appropriate software application and, if necessary, plug in hardware to function as an in-vehicle cyclist proximity warning system device.

A vehicle to vehicle (V2V) and vehicle to infrastructure (V2I) system uses transceivers installed in vehicles to broadcast messages regarding the location, travel direction and speed of the vehicle using limited range wireless signals for reception by transceivers of other vehicles. This can enable the V2V system of a vehicle to warn the driver of any potential problem, such as slow moving traffic, stationary vehicles, emergency vehicles, turning vehicles etc and in some cases the V2V system prevent the driver making an action which could cause an accident. A V2I system can be used in conjunction with a V2V system to also broadcast messages from infrastructure, for example traffic lights and speed signs, for reception by transceivers in vehicles. The in vehicle system can then inform the driver of conditions such as speed limits or pending traffic light changes and in some cases take action to control the vehicle, for example by limiting travel speed to the seep limit. Such systems can also be modified to enable the in vehicle system to receive a cyclist proximity warning signal and inform the driver of the presence of the cyclist as described above. The cyclist proximity warning signal may be the same as a signal broadcast from a vehicle transceiver, for example using the same frequency and data format, but be identifiable as a cyclist proximity signal based on the transmitted data. Alternatively the signal may be different from a vehicle signal and identifiable as a cyclist signal based on the signal characteristics. On the vehicle device receiving the signal it can be identified as a cyclist proximity warning signal and the driver alerted to the presence of the cyclist.

The functionality of the in-vehicle device for the proximity warning system may be integrated into any suitable appliance or accessory. Any vehicle appliance, accessory or stand alone device may be used provided it includes a receiver that is compatible with the transmitter of the proximity warning system transmitter unit.

The controller 225 may be provided in the form of a software upgrade to an existing controller for an in vehicle device, such as a radio or navigation system, where suitable receiver capability already exists within the in vehicle device. For example, some known satellite navigation accessory devices include radio frequency receivers, such as Bluetooth receivers. It is envisaged that a transmitter unit adapted to transmit a proximity warning signal compatible with such receivers may be provided for cyclists. A software upgrade for the controller of the in vehicle device can add functionality for processing the proximity warning signal and issuing an alarm in response to the existing functionality of the device. An in-built radio system may be similarly adapted to receive and process a proximity warning signal.

In an embodiment the in vehicle detection device is a car radio. In this embodiment the transmitter 217 transmits a proximity warning signal on one or more radio frequencies receivable by the radio receiver to alert the driver to the presence of the cyclist. In some embodiments the transmitter unit may be adapted to transmit the proximity warning signal on a plurality of radio frequencies including broadcast radio carrier frequencies. Thus, a proximity warning signal should be transmitted using a frequency currently tuned to by the car radio. In some embodiments the radio may be fitted with an additional receiver, adapted to receive a specified frequency or range of frequencies used for transmission of the proximity warning signal. Thus the cycle mounted transmitter unit need only transmit in this frequency range. It should be appreciated that in these embodiments the vehicle radio antenna is employed for receiving the proximity warning signal, similarly to receiving a radio broadcast signal, thus enabling relatively low power cycle mounted transmitters.

The controller of the car radio, for example a microprocessor controller, may be adapted to switch from reproducing broadcast radio to reproducing a recorded alert message stored in memory, such as reproducing a recorded or synthesized voice saying “BIKE WARNING”, a tone or series of beeps or other distinctive sounds, and optionally displaying a warning on a display device, flashing a light emitting diode or causing another visual alert. In some embodiments the controller may be adapted to automatically turn on the car radio, to provide the alert in response to receiving a proximity warning signal. Thus a driver need not be listening to the radio to be alerted to the presence of the cyclist. In some embodiments the warning may also indicate the number of bikes and direction. For example, “BIKE WARNING, TWO BIKES REAR LEFT”.

The controller can cause the alert message to be repeated until the proximity warning signal is no longer received. The warning message may be repeated a number of times, for example three times. The audible warning may be repeated again after a pause if the proximity warning signal is still being received. The visual alert may be adapted to operate continually while the proximity waring signal is received.

A reason for including a pause for the repetition of the audible warning is constant repetition of the audible warning may be irritating to the driver. For example, if a cyclist is riding beside a car in slow moving traffic or a motorcycle is travelling behind a car in the same lane, the proximity waring signal may be received for several minutes or longer after the vehicle driver has been made aware of the presence of the cyclist. It may become irritating if an audible alert continues for all this time. However, once the driver has been alerted to the presence of the cyclist, the driver can check an optical alert to see whether the cyclist is still close. The driver can then check where the cyclist is before changing lanes, turning corners etc. If a driver cannot see a cyclist but the optical alert shows a cyclist is proximate the vehicle, the driver can check mirrors and blind spots until the cyclist is positively located. The audible warning may also be repeated if there is a change, such as the signal getting stronger or being received from a different direction, to alert the driver to the change.

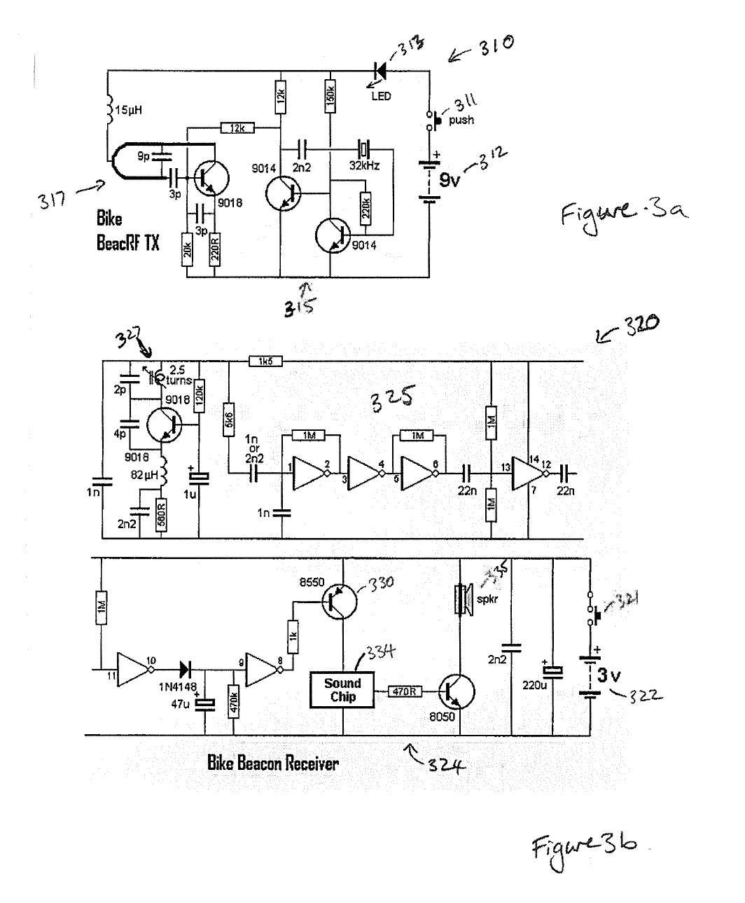

An example of a radio frequency transmitter unit circuit and receiver circuit for a stand alone receiver are illustrated in FIGS. 3a and 3b respectively. The transmitter unit circuit 310 includes a 9V power supply 312 which could also potentially be any specific voltage, control circuit 315 and a resonant circuit portion for the RF transmitter 317. The cyclist can turn the transmitter unit ON and OFF by disconnecting the circuit 315 from the power supply 312 using a switch 311, a light emitting diode 313 is illuminated to show the ON status. When the unit is turned ON, the circuit 315 drives the resonant circuit portion 317 to resonate at a predetermined frequency to generate the signal, which is transmitted as the proximity warning signal. It should be appreciated that a signal of a predetermined frequency may be generated using a hard wired circuit as shown. The circuit may be designed for any selected frequency, by correct selection of circuit components. The illustrated circuit is for exemplary purposes only and the transmitter unit is not limited to the embodiment illustrated.

An example of a compatible receiver circuit 320 for an in vehicle device is illustrated in FIG. 3b. The circuit 320 includes a receiver section 327, control circuit section 325, alarm circuit 324 and power supply 322.

The receiver section 327 is a resonant circuit adapted to be responsive to the proximity warning signal frequency to receive the transmitted proximity warning signal. The received signal is amplified by the control circuit 325 and used turn ON the transistor 330 to drive the alarm circuit 324. The alarm circuit 324 of this embodiment includes a sound chip 334 which generates a warning signal that is reproduced using speaker 335 to alert the driver to the presence of a cyclist. The receiver unit may be manually turned ON and OFF using the switch 321. For example, the device may be turned OFF when the driver exits the vehicle. In some embodiments the device may be adapted to automatically switch OFF, for example after the diver turns off the vehicle ignition. The device may turn OFF a given time after the vehicle ignition is turned off, for example, after a few minutes delay or in response to the vehicle being locked. This can enable the device to continue to operate to alert the driver to the presence of a cyclist and avoid a driver opening the door into the path of an oncoming cyclist.

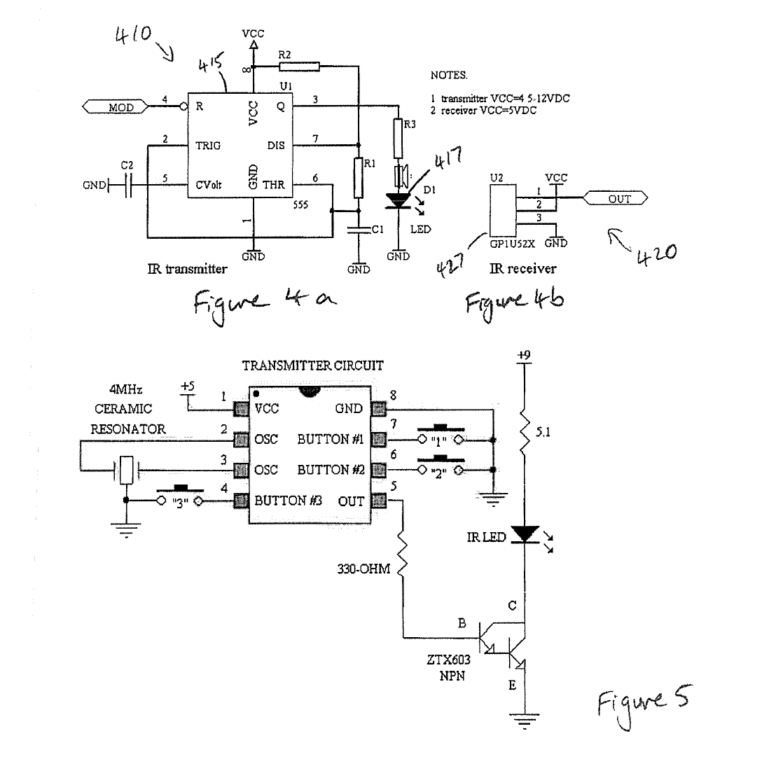

In an alternative embodiment the transmitter unit includes an infra red (IR) transmitter and the in vehicle detection device includes an infra red (IR) receiver. An example of circuits for a transmitter unit and receiver unit for an IR embodiment are illustrated in FIGS. 4a and 4b. In this example, the IR transmitter circuit includes a control chip 415 for driving an IR light emitting diode (LED) transmitter 417, connected to an external power supply (not shown). The IR receiver 420 can be a commercially available IR receiver 427 which may be integrated into vehicle electronics, a stand alone device or vehicle accessory. An alternative IR transmitter unit is illustrated in FIG. 5.

In another alternative embodiment the transmitter unit includes a Bluetooth transceiver. In this embodiment the proximity warning signal can be transmitted using the Bluetooth transceiver and detected by any in vehicle device which also includes a Bluetooth transceiver. For example, the in vehicle device can be any one of a satellite navigation device, mobile telephone, mobile telephone hands free kit, in car communication device, or similar device having a Bluetooth transceiver for example smart phones, tablet computers or the like. A connection can be established between the Bluetooth transceivers of a transmitter unit and an in vehicle receiver unit within range. The Bluetooth interface is adapted to automatically detect devices within range. The in vehicle unit of embodiments of the invention can be adapted to always establish a connection with a cyclist proximity warning system transmitter unit. Once the connection is established the in vehicle unit controller can cause an alert to be issued. In an alternative embodiment, the in vehicle unit may be adapted to identify a detected Bluetooth device as a cyclist proximity warning device and this recognition trigger the alert without requiring a full communication connection to be established between the two devices. Indeed, it is not even necessary to establish a communication connection between the two devices, as recognition of the device type is sufficient to trigger the warning signal. An advantage of this embodiment is that time delay or latency involved in establishing a communication connection before giving the alert can be avoided.

In some embodiments the Bluetooth interface can be used to transmit data regarding the type of cyclist in proximity. For example, data transmitted via a connection established between the Bluetooth devices may identify a motorcycle or bicycle. This enables a more relevant or detailed warning to be given, for example “bicycle alert” or “motorcycle close” so the driver knows what type of vehicle to look for, as well as possible travel speed or acceleration to expect from the cyclist.

As Bluetooth interfaces are provided in many known devices or accessories designed for use in motor vehicles, such devices may be readily adapted for use in a cyclist warning system, for example through device software upgrades. Similarly a smart phone, such as an iPhone™ or Android™ phone may be provided with an application to enable the smart phone to operate as an in vehicle device utilising the Bluetooth interface. Bluetooth enabled tablet computers, PDAs or navigation devices may also be able to be adapted for use in a cyclist waring system through software upgrades. A smart phone device may also be provided with an application to enable the smart phone to operate as a transmitter unit and transmit a proximity warning signal. Although, this example is made with reference to a Bluetooth interface and utilising the Bluetooth transceivers, any suitable transceiver system provided in the device may be used. For example, if a smart phone is provided with an additional short range transceiver system, such as and infrared transceiver system or an alternative short range radio frequency transceiver system, then such transceiver systems may be utilised in combination with a suitable software application to convert the smart phone to a cyclist proximity warning system transmitter unit or in vehicle device. It should be appreciated that enabling devices commonly owned by a significant portion of the population to be easily converted for receiving the cyclist proximity warning signals can facilitate uptake of the system by drivers.

Alternatively an accessory device, such as a satellite navigation device, may include an additional receiver for receiving cyclist proximity warning signals. The additional receiver can be independent of any primary device functionality. For example, a global positioning system (GPS) device can be provided with an additional IR or radio frequency receiver which operates independently of the satellite signal receiver. The cyclist proximity warning signal can be received and processed independently of the GPS signal. The device processor can be adapted to process the cyclist proximity warning signal for alerting the driver, for example using a warning message and audible alarm.

The device may also be adapted to display a cycle position indicator, if the relative direction of origin the proximity warning signal can be determined. For example, where the receiver is adapted to determine a direction or sector from which the proximity warning signal is received, the approximate location of the cyclist may be displayed using an arrow or icon. For example, an icon may be used near a corner or edge of a display to indicate the direction of the cyclist proximity warning signal. If more than one cyclist is near the vehicle an icon may be shown for each cyclist or a cyclist icon may be shown with a number indicating the number of cyclists, or a combination may be used. For example, if the location of each cyclist relative to the vehicle is indicated and two cyclists are in different locations, such as one directly to the rear of the vehicle and another to the side, then two icons may be shown indicating these locations and if there is also a group of three cyclists in front of the vehicle, then a single cyclist icon superimposed with the numeral “3” may be shown. In such embodiments a plurality of receivers may be used to provide the directional capability. Alternatively, signal processing of the received signal may enable identification of the approximate direction of the signal, for example using Doppler characteristics. Where multiple receiver units are placed around the vehicle, the direction may be based on the first receiver to receive the signal or relative signal strength of the proximity warning signal being received by each receiver. Thus, a driver can be alerted to one or more near or approaching cyclists, inclusive of the direction of each cyclist.

In some embodiment the cyclist transmitter unit may be adapted for satellite tracking. Thus, suitably adapted providers of satellite navigation services may therefore utilise the tracking information to transmit to users of their devices. For example, where a satellite navigation system is adapted for live updates, for example warnings of traffic hazards, congestion, accidents etc, this functionality may also be used for providing cyclist tracking information. The cyclist position information can be transmitted to the navigation units within a relevant area for display to the driver.

In an embodiment the transmitter unit and receiver units may include positioning functionality, such and GPS or other satellite navigation functionality and the location of the devices may be tracked or accessed via a communication network. For example, a GPS enables smart phone position may be reported to a tracking service via a communication network and position information may be accessible to other parties via the communication network.

An embodiment of the cyclist proximity warning system may be implemented as a software application which utilises the network accessible location information of mobile phones for providing cyclist proximity warning to drivers via cooperating applications of smart phones or navigation devices. For example, a cyclist can, via a software application on their smart phone or other device register with the tracking service that they are riding a bicycle or motorbike. The tracking service may make the position information for mobile phones registered as cyclists' available to operators of satellite navigation system to enable proximity warnings for cyclists to be transmitted to in car navigation units via a communication network to enable positions of cyclists to be indicated and drivers alerted.

Alternatively a corresponding smart phone application for use by drivers may compare the driver's phone location to the registered cyclists' locations and provide a warning to the driver when a cyclist is proximate their vehicle. It should be appreciated in such embodiments that there may be no direct transmission of signals between the cyclist device and the driver's device, rather the proximity warning is determined based on tracking information obtained via a communication network.

In some embodiments the cyclist proximity warning functionality may be integrated into parking assist, blind spot monitoring or obstacle warning systems. For example, one or more receivers for the cyclist proximity warning signal may be incorporated into equipment for such systems. For example a radar unit or camera for blind spot monitoring or obstacle warning systems may also include a cyclist proximity warning signal receiver. When a cyclist proximity warning signal is received this can be input to the processing system to supplement the data received using the camera or radar to assist in identification of the cyclist. The driver can be warned of the cyclist via the blind spot monitoring alert functionality. Similarly, receivers for proximity warning signals may be provided with parking assist sensors and a signal transmitted to the parking assist system in response to a cyclist proximity warning signal. A parking assist system which is not always on may be adapted to turn on in response to a cyclist proximity warning signal being received. The blind spot monitoring and parking assist functionality may also be modified to stay turned on for a period of time or until the car is locked after the ignition is turned off to enable a driver to be alerted to the proximity of a cyclist. For example, to avoid opening a car door into a cyclist's path.

Alternatively the in vehicle device can be a stand alone device for installation in a vehicle. The in vehicle detection device being adapted to receive the transmitted proximity warning signal and issue an alert in response to a received proximity warning signal. The stand alone device may take any from and be mounted in the vehicle in any suitable manner. Such devices may be stand alone powered or adapted to connect to the vehicle electronic system, for by plugging in to a cigarette lighter or USB port (if provided in the vehicle). The stand alone device may be a single unit suitable for a car, or a have a central unit for mounting near the driver and remote receiver units for mounting around the vehicle, for use with large vehicles. Additional remote receiver units may also be optional additions for an in vehicle device which are used as needed. For example, additional remote receivers may be attached to a trailer, caravan, boat etc that may be occasionally towed behind a car.

Each transmitter unit may be sold with one or more stand alone in vehicle detection units. A cyclist may install an in vehicle detection unit in their own car. Any excess in vehicle detection units can be passed on by the cyclist to other drivers, for example friends or family, thus aiding the uptake of the proximity warning system.

Embodiments may also include dual purpose units, where a unit can switch from a transmitter unit for transmitting a proximity warning signal to a receiver unit for in vehicle use to receive proximity warning signals and provide an alert. For example, a user may have the unit mounted on their bicycle in “transmit” mode. The user can remove the unit and operate a switch to change the unit to a “receive” mode and mount the unit in their car.

In some embodiments a dual purpose unit may be adapted to automatically determine whether it is to perform as a transmitter unit or receiver unit. For example, plugging the unit into a bicycle computer or magnetic speed sensor unit on a bicycle may cause the unit to automatically switch to a transmitter mode. Transmission of the proximity warning signal can them be initiated by sensing movement of the bicycle, i.e. through the magnetic sensor unit. Plugging the unit into a motorcycle and turning on the ignition can cause the unit to switch to a transmitter unit mode. The proximity warning signal may only be transmitted when the motorcycle ignition is on. When the ignition is turned off the unit may switch automatically to receiver mode.

The unit may default to a receiver mode when input from a motorcycle ignition or control system is not detected and input from a bicycle computer or speed sensor is not detected. Thus, when the unit is placed in a car it will already be acting as a receiver. This has an advantage of the driver not needing to do anything to put the unit into receiver mode or even turn on the unit. Alternatively the unit may switch to a receiver mode when connected to a power supply in the car.

Transmitter units may be incorporated into other accessories such as bicycle headlights, bicycle computers or navigation systems designed for mounting on bicycle or motorcycles, and can be pre assembled and sold as combination units. Transmitter units may also be produced that are adapted to be attached to or embedded in children's push bikes, tricycles, ride on toys, walkers and other portable play equipment, such as swing sets, tents or play houses, which may be used in areas near where vehicles may be present. For example, near a driveway, garage, on roads or footpaths. Transmitter units may be attached or embedded in such play equipment so that a driver will be alerted to the presence of such play equipment and can check that it and any children playing are not in danger from the vehicle. For example, a transmitter unit in a child's ride on toy may alert the driver if the toy has been left in the driveway or been ridden into the driveway. Alternatively a transmitter unit in a swing set in a front yard may alert a guest to the house that children's play equipment is near the driveway so they can proceed with caution.

It is known that accidents between cars and children do occur in driveways and garages as most cars have blind spots low to the ground which can conceal a small child. Although reversing cameras may assist in compensating for some of these blind spots, some blind spots can remain. Further, blind spots can exist forward of the driver and low to the ground where blind spot assist cameras are typically not employed. It should be appreciated transmitter units may be added to children's toys or play equipment as a safety feature. In some embodiments the transmitter unit may be adapted to distinguish the type of equipment it is installed in. For example a different proximity warning signal may be emitted if the transmitter unit is a cyclist mode to when used in a child mode. Alternatively if the transmitter unit location is tracked via a communication network, the type of use for the transmitter unit may be registered with a tracking server. For example, the transmitter unit may be registered as used on a bicycle, motorcycle, children's bicycle or ride on toy or children's stationary toy. Thus a different proximity warning may be issued to a driver when the transmitter unit detected is used in relation to children.

In some embodiments the transmitter units may have a standby mode where a short range signal is periodically transmitted so that a warning signal can be given even after the transmitter unit has been stationary for a long period of time. For example, it may be desirable for a transmitter unit on a child's bicycle to be always so a signal will be transmitted if the bicycle has been left in a driveway or the child is sitting on or near the bicycle not moving. Such embodiments may have a manual override mechanism to enable the signal transmission to be turned off, for example if the bicycle is being transported in a car or locked away in a shed.

Preferably transmitter units for installation on bicycles are small, lightweight and easily mounted. For example, transmitter units adapted for mounting of bicycle handlebars. Alternatively, transmitter units may be designed and adapted for mounting on bicycle helmets. In an embodiment the proximity warning transmitter unit may be built into a bicycle helmet. For example, a small transmitter unit can be mounted in the helmet and solar cells or photovoltaic film may be provided on the outside of the helmet for powering the unit or charging batteries.

The higher mounting position on a bicycle helmet may be advantageous where optical transmitters, such as IR transmitters, are used where a direct line of sight between the transmitter and receiver is required. Further, an IR unit for mounting on a bicycle helmet may be provided with a plurality of IR transmitters, each adapted to direct an IR signal in a different direction. In this embodiment helmet mounting may be advantageous as the likelihood of the cyclist's body obstructing the optical proximity warning signal is reduced.

In some embodiments the transmitter unit has a low power consumption standby state where no proximity warning signal is transmitted and a higher power consumption active state wherein the proximity warning signal is transmitted. The transmitter unit is adapted to automatically transition from the standby state to the active state in response to operation of the bicycle or motorcycle.

Where the transmitter unit is adapted for installation on a motorcycle, the transmitter can be adapted to automatically transition from the standby state to the active state in response to turning on the motorcycle engine and transition from the active state to the standby state in response to turning off the motorcycle engine.

Where the transmitter unit is adapted for installation on a bicycle, the transmitter unit can be adapted to automatically transition from a standby state to an active state in response to movement of the bicycle. A signal can be generated by operation of the bicycle pedals or wheels which is received by the transmitter unit to trigger the transition from the standby to the active state.

A transition from the active state to the standby state can be triggered in response to expiration of a specified time period after movement of the bicycle ceases. For example, to avoid the transmitter unit going into standby while the cyclist is waiting at traffic lights, or taking a short break by a road for a rest or to check a map. A transmitter that is battery powered can be fitted with a low battery warning so as to inform owner that batteries need replacing and avoid the vulnerability of riding on the roads with a unit not functioning.

In some embodiments a motion sensor, sensing motion of or near the transmitter may be used to turn the transmitter on. For example, a transmitter may go into a sleep mode where no proximity warning signal is transmitted if no motion of or near the transmitter unit is detected. When and while motion near the transmitter is detected the transmitter unit wile b turned on and transmit a proximity warning signal. For example, a transmitter unit is installed on a child's bicycle, while the child is playing on or near the bike, motion is detected and the transmitter unit remains in a wake state transmitting a proximity warning signal. The child finishes playing with the bike, leaves the bike in the driveway and goes into the house. After a present period of time with no motion detected, for example five minutes, the transmitter unit enters sleep mode and ceases to transmit a proximity warning signal. A car enters the driveway where the bike has been left, the motion of the vehicle is detected by the motion sensor and causes the transmitter unit to transition to the wake state and transmit a proximity warning signal. This signal can warn the driver of the vehicle of the presence of the bike before the vehicle collides with the bike. In some embodiments the motion sensor may be of high enough sensitivity to sense ground vibrations caused by the approach of a vehicle.

It should be appreciated that many possible variations of transmitter and receiver architecture between the transmitter units and in vehicle devices can be used and all such variations are considered within the scope of the invention.

Embodiments of the cyclist warning system can substantially improve the safety of cyclists on the roads. Risks of accidents between cyclists and motorists can be significantly reduced. The system can also be particularly useful for children, in particular to reduce risks of accidents between cars and children on bikes in and around driveways.

Insurance companies may also be induced to reduce vehicle insurance premiums where vehicles are installed with a cyclist proximity warning device, due to the reduction in accident risk. It should be appreciated that the potential for injury or fatality for accidents involving cyclists is very high, even for relatively minor accidents. This can result in high insurance costs for hospitalisation and rehabilitation, typically. From a vehicle driver's perspective, in addition to the monetary cost of any damage to vehicles, the human damage as a result of an accident between a car and a cyclist can cause high emotional stress for a diver. Thus, use of the system can alleviate driver stress as the proximity of cyclists can be more easily known.

In the claims which follow and in the preceding description, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It is to be understood that, if any prior art publication is referred to herein, such reference does not constitute an admission that the publication forms a part of the common general knowledge in the art, in Australia or any other country.

1. A cyclist proximity warning system comprising:
one or more cyclist transmitter units each for carrying on a bicycle or motorcycle, each transmitter unit being adapted to transmit a signal indicating the location of the transmitter unit and the bicycle or motorcycle carrying the unit; and
one or more in vehicle driver alert devices each driver alert device for carrying in a vehicle and having a receiver adapted to receive a cyclist proximity warning signal indicating presence of a cyclist proximate the vehicle and in response to receiving the signal alert the vehicle driver to the presence of a cyclist proximate the vehicle.

2. A system as claimed in claim 1 wherein the cyclist transmitter units are adapted to transmit a limited range wireless cyclist proximity warning signal for reception by any in vehicle driver alert device receiver within range of the proximity warning signal.

3. A system as claimed in claim 2 wherein the range of the proximity warning signal is adjustable.

4. A system as claimed in claim 3 wherein the range of the proximity warning signal is dynamically adjusted based on travelling speed of the cyclist.

5. A system as claimed in claim 2 wherein the cyclist transmitter unit has a low power consumption standby state where no proximity warning signal is transmitted and a higher power consumption active state wherein the proximity warning signal is transmitted, and the transmitter unit is adapted to automatically transition from the standby state to the active state in response to operation of the bicycle or motorcycle.

6. A system as claimed in claim 5 where the cyclist transmitter unit is adapted for installation on a motorcycle and the cyclist transmitter unit is adapted to automatically transition from the standby state to the active state in response to turning on the motorcycle engine and transition from the active state to the standby state in response to turning off the motorcycle engine.

7. (canceled)

8. (canceled)

9. A system as claimed in claim 5 wherein a transition from the active state to the standby state is triggered in response to expiration of a specified time period after movement of the bicycle ceases .

10. A system as claimed in claim 2 wherein an in vehicle driver alert device comprises one or more associated receivers for mounting to a vehicle and any trailer, wherein each receiver adapted to receive a cyclist proximity warning signal from a cyclist transmitter unit and in response to any one or more receivers receiving a cyclist proximity warning signal cause a diver alert to issue.

11. A system as claimed in claim 10 wherein each of the receivers is remote from a driver alert device proximate the driver and each receiver is in data communication with the driver alert device via a communication link

12. A system as claimed in claim 11 wherein the communication link is a wireless communication link

13. A system as claimed in claim 12 wherein the communication link is a Bluetooth communication link

14. A system as claimed in claim 13 wherein the driver alert device is a Bluetooth enabled accessory device and can be any one of: a navigation device; a mobile telephone; smart phone; tablet or palm top computer; or personal digital assistant.

15. A system as claimed in claim 2 wherein the in vehicle detection device receiver is a radio receiver device.

16. A system as claimed in claim 15 wherein the in vehicle detection device is a car radio and wherein the transmitter transmits a proximity warning signal on one or more radio frequencies receivable by the radio receiver to alert the driver to the presence of the cyclist.

17. A system as claimed in claim 16 wherein the signal causes an audible warning message to be reproduced through the car radio when the proximity warning signal is received.

18. A system as claimed in claim 1 wherein the cyclist transmitter unit includes an infra red (IR) transmitter and the in vehicle detection device includes an infra red (IR) receiver.

19. (canceled)

20. A system as claimed in claim 19 wherein the in vehicle device is any one of a satellite navigation device, mobile telephone hands free kit, in car communication device, or similar device having a Bluetooth transceiver.

21. A system as claimed in claim 1 wherein transmitter units are adapted to send the signal indicating the location of the cyclist transmitter unit to a communication network accessible server storing cyclist tracking data, and wherein a cyclist proximity warning signal is transmitted to the in vehicle driver alert device from the communication network accessible server in response to identification of a cyclist proximate a vehicle based on vehicle location.

22. (canceled)

23. A system as claimed in claim 21 wherein the in vehicle driver alert device is a smart phone or other communication network enabled device enabled for location tracking and cyclist tracking data and executing a cyclist proximity warning software application.

24. (canceled)

25. A system as claimed in claim 1 wherein the in vehicle detection device is adapted to identify the approximate direction of origin of the proximity warning signal and indicate the approximate direction for the driver.

26. (canceled)

27. A system as claimed in claim 1 further comprising one or more cyclist transmitter units adapted to be attached or incorporated in children's play equipment whereby a vehicle driver can be alerted to the presence of the children's play equipment proximate the vehicle.

28. (canceled)

29. A transmitter adapted to transmit a proximity warning signal having a specified range, whereby the proximity warning signal can be detected by an in vehicle device of a vehicle within range of the proximity warning signal and in response a motor vehicle driver alerted to the presence of a cyclist proximate the vehicle.

30. (canceled)

31. (canceled)

32. A software application adapted to, when executing on a portable communication network accessible communication device, to cause the device to operate as an in vehicle driver alert device of a system as claimed in claim 21.

33. A receiver unit adapted to receive a proximity warning signal and, in response to receiving a proximity warning signal, output a signal to trigger an alert to warn a vehicle driver of the presence of a cyclist.

34. (canceled)

35. (canceled)

36. (canceled)
